(19) United States
(12) Patent Application Publication
(10) Pub. No.: US 2025/0100902 A1
(43) Pub. Date: Mar. 27, 2025

(54) EFFLUENT LIQUID EVAPORATOR

(71) Applicants: QUADSUN SOLAR PRIVATE LIMITED, Gurgaon (IN); Aquality Solutions, LLC, Frisco, TX (US)

(72) Inventor: Prakash BHALEKAR, Gurgaon (IN)

(21) Appl. No.: 18/892,613

(22) Filed: Sep. 23, 2024

(30) Foreign Application Priority Data
Sep. 21, 2023 (IN) 202311063584

(51) Int. Cl. C02F 1/04; B01D 1/00; B01D 1/30; C02F 1/14

(52) U.S. Cl. CPC C02F 1/048; B01D 1/0035; B01D 1/0041; B01D 1/0064; B01D 1/0082; B01D 1/0094; B01D 1/30; C02F 1/043; C02F 1/14; C02F 2209/02; C02F 2209/38; C02F 2303/14; C02F 2303/22

(57) ABSTRACT

The present invention relates to an effluent liquid evaporator (100) to treat wastewater by increasing the evaporation rate with easy and automatic cleaning in an economical manner. The effluent liquid evaporator (100) comprises a pan module (101), a fan module (102), a set of sensors (103) and an injection unit (104). The injection unit (104) is configured to inject a controlled amount of effluent in said pan module (101). The pan module (101) include a plurality of stack of pans (105) to retains the desired amount of effluent to be heated via solar energy which results in evaporation of the effluent. The fan module (102) provides a direct and balanced airflow and facilitates rapid evaporation leaving behind a residue. The set of sensors (103) are configured to perform closing and opening operation on a set of vents for mixing fresh air with a humid air for increasing an evaporation rate of the pre-defined amount of effluent.

### FIELD OF THE INVENTION

The present invention relates to an effluent liquid evaporator. More particularly, the present invention relates to an effective and sustainable evaporator to treat wastewater by increasing the evaporation rate with easy and automatic cleaning in an economical manner.

### BACKGROUND OF THE INVENTION

Effluent liquid refers to any waste liquid or discharge that produces byproduct of industrial, agricultural, or domestic activities, other than the kitchen or toilet wastes. It particularly contains one or more contaminants including fats, chemicals, detergents, heavy metal rinses, solids and food waste that comes from various sources such as manufacturing processes, wastewater treatment plants, agricultural operations and sewage systems. Therefore, there is a requirement of treating wastewater before being released into the environment.

Wastewater treatment refers to the process of removing impurities from wastewater before the wastewater is delivered back into the environment to reduce the potential harm affecting the human health and the environment and to reuse or recycle the wastewater for various purposes.

Treating wastewater possess various challenges that needs to be addressed to ensure effective and sustainable wastewater management that involves technological advancements, policy reforms, public engagement, financial support and to prioritize investments in upgrading and expanding wastewater treatment infrastructure.

The conventional approach of the effluent liquid treatment, which includes various stages of filtration comprising primary treatment, secondary treatment and tertiary treatment. Primary treatment involves removal of solids, oil and grease, removal of floating & settable such as suspended solids, organic matter, and secondary treatment involves removal of biodegradable organic matter (BOD), and tertiary treatment involves removal of residual suspended solids and dissolved solids. However, the method is complex and requires high power to implement. This is followed by a water recycle process such as Reverse Osmosis and finally evaporation of the brine concentrate.

US20190330082A1 discloses a system and method for separating surface materials from a fluid, such as foam, sludge, oil or grease, at a fluid's surface, by applying acoustic pressure shock waves to the material and the fluid's surface such that acoustic pressure shock waves are propagated in liquid medium of the fluid and in gas medium above the fluid surface. However, this invention fails to provide an easy and automatic solution that consumes less power.

U.S. Pat. No. 8,147,700B2 discloses a wastewater treatment system and method comprises a treatment chamber having a filtration membrane spanning an effluent outlet of the chamber and a pair of electrodes in the treatment chamber so as to be in communication with the wastewater. An electrical potential difference is applied between the electrodes such that one of the electrodes functions as an anode and one of the electrodes functions as a cathode. A flow of fluid is induced out of the treatment chamber through the filtration membrane to the effluent outlet. Accordingly, the treatment chamber is arranged to biologically treat the wastewater, electrochemically treat the wastewater and mechanically filter the wastewater through the filtration membrane commonly therein. However, the maintaining and cleaning of this system is more challenging due to limited access to the treatment chamber and associated components.

KR101590408B1 discloses a small-scale wastewater treatment system which comprises a first settling tank, an electrolysis tank, a second settling tank, a gravity-type two-stage sand filtering apparatus, a pulsed ultra violet treatment tank, a ball mill crushing apparatus, and a sludge drying system. The treatment system of the present invention eliminates nitrogen and phosphorus, and allows sludge to be eluted from the settling tank after insertion of an acetic acid compound as a coagulant. In addition, a dried sludge cake is produced after drying the sludge in the sludge drying system, and treated water is discharged after final sterilization by pulsed ultra violet treatment tank. However, this invention fails to provide an easy and automatic solution that consumes less power.

Therefore, due to the above aforementioned drawbacks, there is a need of a system for treating effluent liquid that is economic, easy to operate, easy to clean and consumes less power.

### OBJECT OF THE INVENTION

The main object of the present invention is to provide an effluent liquid evaporator to treat the wastewater.

Another object of the present invention is to provide an effluent liquid convection enhanced evaporator to improve evaporation and ease of maintenance.

Yet another object of the present invention is to provide an effluent liquid evaporator with a single point injection unit which uniformly spreads the effluent liquid on the evaporating surface.

Yet another object of the present invention is to provide an effluent liquid evaporator with a single point injection unit that varies the injection quantity on the evaporating surface over time and space.

Yet another object of the present invention is to provide an effluent liquid evaporator with an easily accessible and automatically cleanable injection unit.

Yet another object of the present invention is to provide an effluent liquid evaporator with the single point injection unit for low pressure drop, thereby reducing power consumption.

Yet another object of the present invention is to provide an effluent liquid evaporator with an with an arrangement of the single point injection units and evaporating surfaces that allows for frequent and light cleaning of the evaporation surfaces.

Yet another object of the present invention is to provide an effluent liquid evaporator with push-pull fan module to achieve high-speed airflows.

Still another object of the present invention is to provide an effluent liquid evaporator with less cost of operations and works in low power.

### SUMMARY OF THE INVENTION

The present invention relates to an effluent liquid evaporator with easy and automatic cleaning of the effluent liquid to recycle the liquid for other purposes and to increase evaporation rates.

In an embodiment, the present invention provides an effluent liquid evaporator comprising a pan module, a fan module, a set of sensors, and an injection unit. The injection unit is a single point injection unit and said injection unit is configured to inject a controlled amount of effluent in said pan module. The pan module includes a plurality of horizontally arranged stack of pans and said stack of pans retain the desired amount of effluent that is provided by said injection unit and the desired amount of effluent in the stack of pans is heated via solar energy which results in evaporation of the effluent. The fan module is a push-pull fan module that provides a direct and balanced airflow to equally spread the effluent on said plurality of stack of pans and facilitates rapid evaporation leaving behind a residue. The set of sensors are configured to perform at least one of a close operation and an open operation on a set of vents present in the evaporator unit for mixing fresh air with a humid air for increasing an evaporation rate of the pre-defined amount of effluent.

The above objects and advantages of the present invention will become apparent from the hereinafter set forth brief description of the drawings, detailed description of the invention, and claims appended herewith.

### BRIEF DESCRIPTION OF THE DRAWING

An understanding of the effluent liquid evaporator of the present invention may be obtained by reference to the following drawings:

FIG. 1 is a block diagram of an effluent liquid evaporator according to an embodiment of the present invention.

FIG. 2 is a perspective view of an effluent liquid evaporator according to an embodiment of the present invention.

FIG. 3 is a perspective view of stack of pan according to an embodiment of the present invention.

FIG. 4 is a perspective view of a single pan according to an embodiment of the present invention.

FIG. 5 is a perspective view of a pan module according to an embodiment of the present invention.

FIG. 6 is a perspective view of a frame structure according to an embodiment of the present invention.

FIG. 7(a) and FIG. 7(b) are perspective views of pan module and frame structure of the effluent liquid evaporator according to an embodiment of the present invention.

FIG. 8 is a perspective view of the adjustable trolley according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides an evaporator for treating waste liquid with a cost-effective and an ease in operation approach to maximize the evaporation rates for removing contaminants from the wastewater.

In an embodiment, the present invention provides an effluent liquid evaporator comprising a pan module, a fan module, a set of sensors, and an injection unit. The injection unit is a single point injection unit and said injection unit is configured to inject a controlled amount of effluent in said pan module. The pan module include a plurality of horizontally arranged stack of pans and said stack of pans retains the desired amount of effluent that is provided by said injection unit and the desired amount of effluent in the stack of pans is heated via solar energy which results in evaporation of the effluent. The fan module is a push-pull fan module that provides a direct and balanced airflow to equally spread the effluent on said plurality of stack of pans and facilitates rapid evaporation leaving behind a residue. The set of sensors are configured to perform at least one of a close operation and an open operation on a set of vents present in the evaporator unit for mixing fresh air with a humid air for increasing an evaporation rate of the pre-defined amount of effluent.

In an exemplary configuration, the pan module including three sides are fixed with a pan cover and said pan cover of right side panel is removable, including 4 stack of pans each containing 15 pans. The stack of 15 cpans is placed in a frame structure. The plurality of stack of pans are assembled with the single point injection unit.

The effluent liquid evaporator for cleaning the pan module works via a method comprising the steps of: (a) removing the right side pan cover sheet that is fixed with said pan module, (b) sliding stack of pans from the pan module, (c) sliding said stack of pans from the pan module to the adjustable trolley, (d) moving the adjustable trolley to a pan cleaning machine, (e) removing single pan from said stack of pans and putting single pans in said pan cleaning machine.

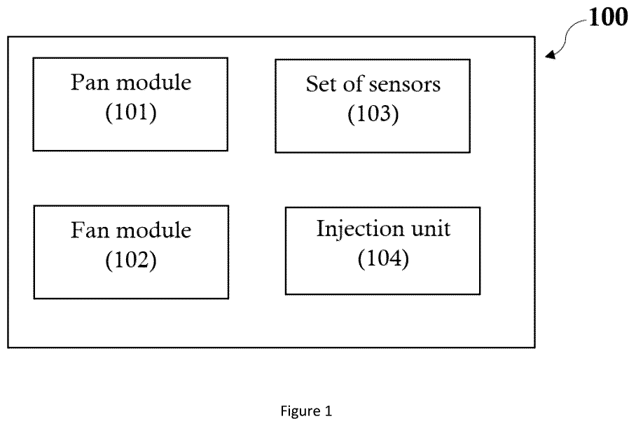

Referring to FIG. 1, a block diagram of an effluent liquid evaporator (100) is depicted. The effluent liquid evaporator (100) comprising a pan module (101), a fan module (102), a set of sensors (103) and an injection unit (104).

The injection unit (104) is a single point injection unit and said injection unit (104) is configured to inject a controlled amount of effluent in said pan module (101).

The pan module (101) includes a plurality of horizontally arranged stack of pans (105) and said stack of pans (105) retains the desired amount of effluent that is provided by said injection unit (104) and the desired amount of effluent in the stack of pans is heated via solar energy which results in evaporation of the effluent.

The injection unit (104) comprises of a pump and a valve to supply the controlled amount of effluent liquid onto said plurality of stack of pan (105) and said injection unit (104) includes a plurality of injection pipes which are vertically assembled for avoiding the direct airflow path thereby reducing issue of pressure drop and airflow restrictions. The controlled amount of effluent is defined by an operator of the effluent liquid evaporator (100) according to requirement.

The fan module (102) is a push-pull fan module that provides a direct and balanced airflow to equally spread the effluent on said plurality of stack of pans (105) and facilitates rapid evaporation leaving behind a residue.

The set of sensors (103) are configured to perform at least one of a close operation and an open operation on a set of vents present in the evaporator unit for mixing fresh air with a humid air for increasing an evaporation rate of the pre-defined amount of effluent. The set of sensors (103) include a humidity detection sensor for measuring a humidity level, temperature sensor for measuring a temperature level. The set of sensors (103) are connected with a processor that processes the humidity level and the temperature level for performing the at least one of a close operation and an open operation on the set of vents present in the evaporator unit.

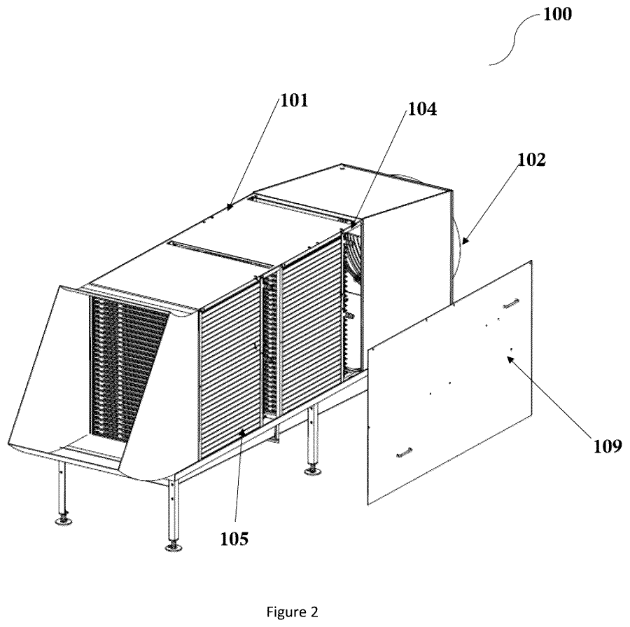

Referring to FIG. 2, a perspective view of an effluent liquid evaporator (100) according to an embodiment of the present invention is depicted. The effluent liquid evaporator (100) comprising a pan module (101), a fan module (102), a set of sensors (103) and an injection unit (104).

The pan module (101) includes a plurality of horizontally arranged stack of pans (105) and said stack of pans (105) retain the desired amount of effluent that is provided by said injection unit (104) and the desired amount of effluent in the stack of pans (105) is heated via solar energy which results in evaporation of the effluent. The pan module (101) includes three sides enclosed by a pan cover (109), with the right side of said pan cover (109) being constructed for easy removal, facilitating in cleaning of the module (101).

The effluent liquid evaporator (100) is equipped with an automated scrappers configured to navigate within said pan module (101) to remove the residue that include salt, debris, dirt or unwanted materials from said pan module (101). The automated scrappers includes one or more mechanical devices such as blades, brushes or other scraping elements to remove salts, debris, dirt or unwanted materials from said pan module (101).

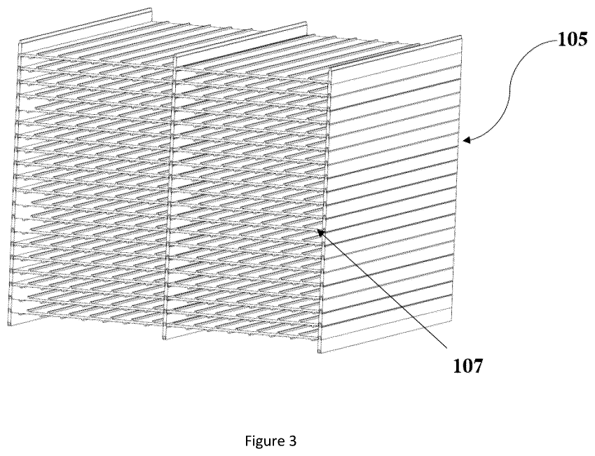

Within the pan module (101) there are a total 4 stack of pan (105). In turn, each stack of pan (105) accommodates 15 individual pans (107) (shown in FIG. 3), resulting in a grand total of 60 pans.

The injection unit (104) comprises of a pump and a valve to supply the controlled amount of effluent liquid onto said plurality of stack of pan (105) and said injection unit (104) include a plurality of injection pipes which are vertically assembled for avoiding the direct airflow path reduces an issue of pressure drops, reduces airflow restrictions.

The fan module (102) is a push-pull fan module that provides a direct and balanced airflow to equally spread the effluent on said plurality of stack of pans (105) and facilitates rapid evaporation leaving behind a residue. The fan module (102) is installed at the one end of the said effluent liquid evaporator (100) and pan module (101) positioned in the middle of said effluent liquid evaporator (100) to heat the effluent via solar energy. The other end of said effluent liquid evaporator (100) is open to allow air sucked by said fan module (102) to flow out through said effluent liquid evaporator (100).

The effluent liquid evaporator (100) is made up of a plurality of transparent sheets which allows sunlight to enter inside the evaporator unit which increasing the evaporation rate of the pre-defined amount of effluent said effluent liquid evaporator (100) is coated with an absorbent coating for absorbing solar energy. The evaporator (100) include an evaporator annulus with a reflective bottom to trap energy for heating the effluent.

Referring to FIG. 3, a perspective view of stack of pan (105) liquid evaporator (100) according to an embodiment of the present invention is depicted. The stack of pans (105) is formed by placing single pans (107) one above another and placed in a frame structure (106). The plurality of stack of pans (105) placed in a box frame (106) and said pan module (101) is configured to receive said a box frame (106) through a sliding mechanism.

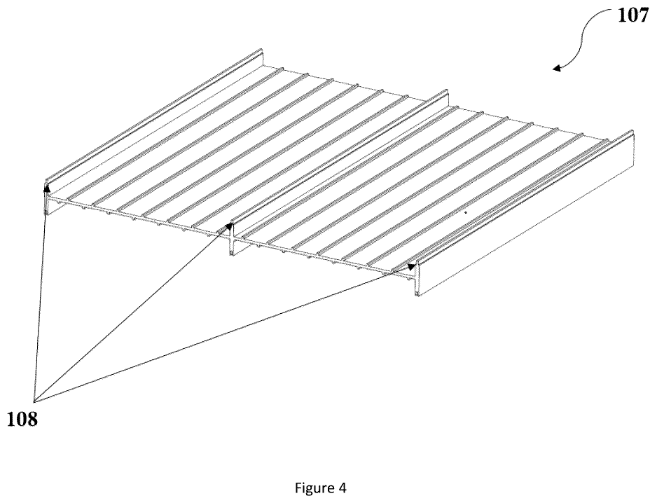

Referring to FIG. 4, a perspective view of a single pan (107) according to an embodiment of the present invention is depicted. The single pan (107) of said stack of pans (105) is of grill shape pan having a longitudinal running protrusion (108) at each end and middle provided to easily assemble said single pans (107) one above the another to maximize a surface area and facilitates the maximum exposure of the effluent to air, thereby accelerating evaporation of the effluent and are placed in a such a manner that a pre-defined amount of space is maintained between each single pan (107) which facilitates in smooth cleaning of the plurality of single pans (107).

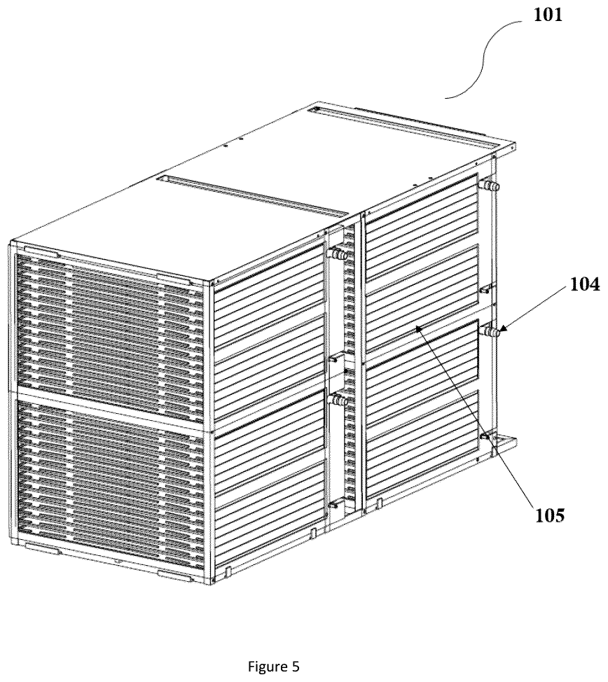

Referring to FIG. 5, a perspective view of a pan module (101) according to an embodiment of the present invention is depicted. The pan module (101) include a plurality of horizontally arranged stack of pans (105) and said stack of pans (105) retains the desired amount of effluent that is provided by said injection unit (104) and the desired amount of effluent in the stack of pans (105) is heated via solar energy which results in evaporation of the effluent. The plurality of stack of pans (105) placed in a box frame (106) and said pan module (101) is configured to receive said box frame (106) through a sliding mechanism.

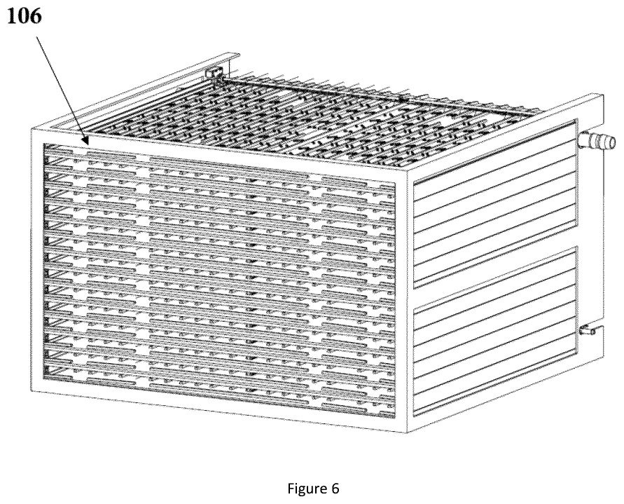

Referring to FIG. 6, a perspective view of a frame structure (106) according to an embodiment of the present invention is depicted. The frame structure (106) including all the 15 pans (107) are assembled with the single point injection unit (104) and said frame structure (106) is removable. The weights of the pans (107) of the frame structure (106) having the weight of 1 pan is 1.9 kg, weight of 15 pans (107) is 28.5 kg, weight of total 15 pans (107) without residue is 33.5 kg, weight of 2 kg of residue per pan weight is 3.9 kg, and weight of total 15 pans (107) weight with residue is 63.5 kg.

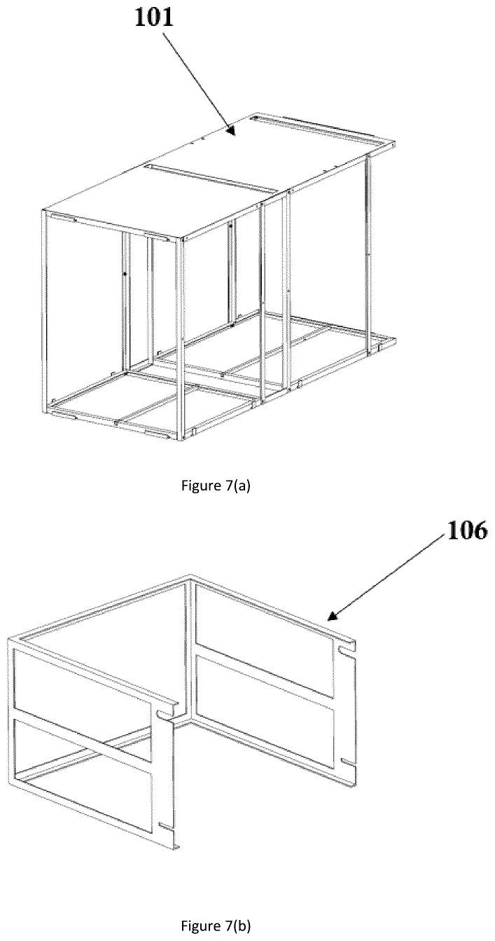

Referring to FIG. 7(a) and FIG. 7(b), perspective views of pan module (101) and frame structure (106) according to an embodiment of the present invention are depicted. The dimensions of the pan module (101) measure approximately 880*624*1272, while the frame structure (106) has preferred dimensions of 608*390*621. The pan module (101) is intended to house four stack of pans (105), each of which contains 15 pans (107). These stack of pans (105) are constructed to be removable, allowing for the easy cleaning of the numerous pans (107) they contain. The stack of pans (105) placed in a box frame (106) and are then transferred using this sliding mechanism into said pan module (101).

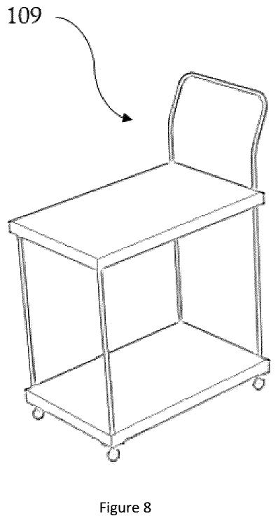

Referring to FIG. 8, is a perspective view of the adjustable trolley according to an embodiment of the present invention is depicted. This trolley (109) is maneuvered to transport the pans to a specialized pan cleaning machine. The cleaning process involves removing a single pan (107) from each stack of pan (105) and placing it into the cleaning machine, thus facilitating the efficient cleaning of the entire set of pans (107).

### Example 1

### Use Case Scenario

The effluent liquid evaporator (100) provides an effective and sustainable evaporator to treat wastewater by increasing the evaporation rate with easy and automatic cleaning in an economical manner. The controlled amount of effluent is injected in a pan module (101) through an injection unit (104). The pan module (101) include a plurality of horizontally arranged stack of pans (105) and said stack of pans (105) retains the desired amount of effluent injected by the injection unit (104). The effluent is heated via solar energy which results in evaporation of the effluent and leaving behind a residue on the surface of said stack of pans (105). The evaporator (100) has a fan module (102) installed at the one end of the said effluent liquid evaporator (100) and pan module (101) positioned in the middle of said effluent liquid evaporator (100) to heat the effluent via solar energy. The other end of said effluent liquid evaporator (100) is open to allow air sucked by said fan module (102) to flow out through said effluent liquid evaporator (100) and facilitates rapid evaporation leaving behind a residue.

Therefore, the present invention provides an effective and sustainable evaporator to treat wastewater by increasing the evaporation rate with easy and automatic cleaning in an economical manner.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. An effluent liquid evaporator (100), comprising:
a pan module (101);
a fan module (102);
a set of sensors (103); and
an injection unit (104);
wherein,
said injection unit (104) is a single point injection unit and said injection unit (104) is configured to inject a controlled amount of effluent in said pan module (101);
said pan module (101) includes a plurality of horizontally arranged stack of pans (105) and said stack of pans (105) retains the desired amount of effluent that is provided by said injection unit (104) and the desired amount of effluent in the stack of pans (105) is heated via solar energy which results in evaporation of the effluent;
said fan module (102) is a push-pull fan module that provides a direct and balanced airflow to equally spread the effluent on said plurality of stack of pans (105) and facilitates rapid evaporation leaving behind a residue;
said set of sensors (103) are configured to perform at least one of a close operation and an open operation on a set of vents present in the evaporator unit for mixing fresh air with a humid air for increasing an evaporation rate of the pre-defined amount of effluent.

2. The effluent liquid evaporator (100) as claimed in claim 1, wherein said plurality of stack of pans (105) are placed in a frame structure (106) through a sliding mechanism.

3. The effluent liquid evaporator (100) as claimed in claim 1, wherein each single pan (107) from said stack of pans (105) is of grill shape pan that have a longitudinal running protrusion (108) at each end and a middle portion to easily assemble said stack of pan (105) one above the another.

4. The effluent liquid evaporator (100) as claimed in claim 3, wherein said pan (107) is placed one above the other to maximize a surface area and facilitates the maximum exposure of the effluent to air, thereby accelerating evaporation of the effluent.

5. The effluent liquid evaporator (100) as claimed in claim 3, wherein said pan (107) is placed in a such a manner that a pre-defined amount of space is maintained between each single pan (107) which facilitates in smooth cleaning of the plurality of pans (107).

6. The effluent liquid evaporator (100) as claimed in claim 1, wherein said injection unit (104) comprises of a pump and a valve to supply the controlled amount of effluent liquid onto said plurality of stack of pan (105).

7. The effluent liquid evaporator (100) as claimed in claim 1, wherein said injection unit (104) include a plurality of injection pipes which are vertically assembled for avoiding the direct airflow path consequently reducing an issue of pressure drop and airflow restrictions.

8. The effluent liquid evaporator (100) as claimed in claim 1, wherein said pan module (101) includes three sides enclosed by a pan cover (109) with the one side of said pan cover (109) being constructed for easy removal, facilitating in cleaning of the module (101).

9. The effluent liquid evaporator (100) as claimed in claim 1, wherein the evaporator (100) is made up of a plurality of transparent sheets which allows sunlight to enter inside the evaporator unit which increases the evaporation rate of the pre-defined amount of effluent.

10. The effluent liquid evaporator (100) as claimed in claim 1, wherein the evaporator (100) is coated with an absorbent coating for absorbing solar energy.

11. The effluent liquid evaporator (100) as claimed in claim 1, wherein the evaporator (100) include an evaporator annulus with a reflective bottom to trap energy for heating the effluent.

12. The effluent liquid evaporator (100) as claimed in claim 1, wherein said evaporator (100) is equipped with an automated scrappers configured to navigate within said pan module (101) to remove the residue that include salt, debris, dirt or unwanted materials from said pan module (101).

13. The effluent liquid evaporator (100) as claimed in claim 13, wherein said automated scrappers includes one or more mechanical devices such as blades, brushes or other scraping elements to remove salts, debris, dirt or unwanted materials from said pan module (101).

14. The effluent liquid evaporator (100) as claimed in claim 1, wherein said set of sensors (103) include a humidity detection sensor for measuring a humidity level, temperature sensor for measuring a temperature level.

15. The effluent liquid evaporator (100) as claimed in claim 1, wherein said set of sensors (103) are connected with a processor that processes the humidity level and the temperature level for performing the at least one of a close operation and an open operation on the set of vents present in the evaporator unit.
